(19) United States
(12) Patent Application Publication
(10) Pub. No.: US 2016/0138990 A1
(43) Pub. Date: May 19, 2016

(54) Electronic Device, Physical Quantity Sensor, Pressure Sensor, Altimeter, Electronic Apparatus, And Moving Object

(71) Applicant: Seiko Epson Corporation, Tokyo (JP)

(72) Inventor: Nobuyuki Tanaka, Chino-shi (JP)

(21) Appl. No.: 14/939,407

(22) Filed: Nov. 12, 2015

(30) Foreign Application Priority Data
Nov. 17, 2014 (JP) 2014-232594

(51) Int. Cl. G01L 9/00

(52) U.S. Cl. CPC G01L 9/0054

(57) ABSTRACT

A physical quantity sensor includes a substrate, a piezoresistive element disposed on one surface side of the substrate, a wall portion disposed to surround the piezoresistive element, in a plan view of the substrate, on the one surface side of the substrate, and a covering layer disposed on the side opposite to the substrate with respect to the wall portion and constituting a cavity together with the wall portion. The covering layer includes a corner portion configured to include two sides adjacent to each other in the plan view, and a reinforcing portion disposed to couple the two sides.

### CROSS REFERENCE

This application claims benefit of Japanese Application JP 2014-232594, filed on Nov. 17, 2014. The disclosure of the prior application is hereby incorporated by reference herein in its entirety.

### BACKGROUND

1. Technical Field

The present invention relates to an electronic device, a physical quantity sensor, a pressure sensor, an altimeter, an electronic apparatus, and a moving object.

2. Related Art

Electronic devices including a cavity that is formed using a semiconductor manufacturing process are known (e.g., see JP-A-2014-115208). As one example of the electronic devices, for example, a MEMS element according to JP-A-2014-115208 can be mentioned. The MEMS element includes a substrate, a resonator formed on a main surface of the substrate, and a space wall portion formed on the main surface of the substrate and forming a space to accommodate the resonator. Moreover, in the MEMS element according to JP-A-2014-115208, a portion of the substrate is reduced in thickness and functions as a diaphragm. Based on a change in the frequency characteristics of the resonator caused by the deflection of the diaphragm under pressure, the pressure is detected.

However, the MEMS element according to JP-A-2014-115208 has a problem that damage such as a crack occurs in a ceiling portion of the space wall portion.

### SUMMARY

An advantage of some aspects of the invention is to provide an electronic device and a physical quantity sensor each having excellent reliability. Another advantage of some aspects of the invention is to provide a pressure sensor, an altimeter, an electronic apparatus, and a moving object each including the electronic device.

The advantages can be achieved by the following application examples of the invention.

### Application Example 1

An electronic device according to this application example of the invention includes: a substrate; a functional element disposed on one surface side of the substrate; a wall portion disposed to surround the functional element, in a plan view of the substrate, on the one surface side of the substrate; and a ceiling portion disposed on the side opposite to the substrate with respect to the wall portion and constituting an interior space together with the wall portion, wherein the ceiling portion includes a corner portion configured to include two sides adjacent to each other in the plan view, and a coupling portion disposed to couple the two sides.

According to the electronic device, the ceiling portion can be effectively reinforced with the coupling portion (hereinafter also referred to as “reinforcing portion”), so that damage caused by a difference in strength between the corner portion of the ceiling portion and a portion thereof adjacent to the corner portion can be reduced. Therefore, the electronic device according to the application example of the invention has excellent reliability.

### Application Example 2

In the electronic device according to the application example of the invention, it is preferable that the coupling portion is located on the interior space side of the ceiling portion.

With this configuration, a reinforcing effect of the reinforcing portion can be made excellent. Moreover, when the wall portion is formed using a photolithographic technique and an etching technique, the reinforcing portion can be formed using an antireflection film used in photolithographic exposure, and thus a manufacturing step can be simplified.

### Application Example 3

In the electronic device according to the application example of the invention, it is preferable that the coupling portion located on the interior space side contains titanium nitride.

With this configuration, when the ceiling portion is configured using aluminum, a difference in thermal expansion between the ceiling portion and the reinforcing portion can be reduced. Therefore, when thermal shrinkage or the like occurs in the ceiling portion, stress concentration occurring in the ceiling portion can be reduced, and thus damage to the ceiling portion can be reduced.

### Application Example 4

In the electronic device according to the application example of the invention, it is preferable that the coupling portion is located on the side of the ceiling portion opposite to the interior space.

With this configuration, when a protective film is provided, the reinforcing portion and the protective film can be formed collectively, and thus the manufacturing step can be simplified.

### Application Example 5

In the electronic device according to the application example of the invention, it is preferable that the coupling portion located on the side opposite to the interior space includes a first layer configured to contain silicon oxide, and a second layer disposed on the side opposite to the interior space with respect to the first layer and configured to contain silicon nitride.

With this configuration, the reinforcing portion and the protective film can be formed collectively.

### Application Example 6

In the electronic device according to the application example of the invention, it is preferable that the coupling portion includes a first coupling portion, and a second coupling portion disposed on the side opposite to the interior space with respect to the first coupling portion, and that at least a portion of the ceiling portion is disposed between the first coupling portion and the second coupling portion.

With this configuration, the reinforcing effect of the reinforcing portion can be made excellent while simplifying the manufacturing step.

### Application Example 7

In the electronic device according to the application example of the invention, it is preferable that the coupling portion contains a material with a lower thermal expansion rate than that of the ceiling portion.

With this configuration, the thermal shrinkage or thermal expansion of the ceiling portion can be reduced.

### Application Example 8

In the electronic device according to the application example of the invention, it is preferable that the coupling portion includes a portion having a shape extending in a direction inclined to the two sides.

With this configuration, the mass of a structure formed of the ceiling portion and the reinforcing portion can be reduced, and the deflection of the ceiling portion can be reduced. Therefore, damage to the ceiling portion can be reduced more effectively.

### Application Example 9

In the electronic device according to the application example of the invention, it is preferable that the substrate is provided at a position overlapping the ceiling portion in the plan view, and includes a diaphragm portion that is deflected and deformed under pressure.

With this configuration, an electronic device (physical quantity sensor) capable of detecting pressure can be realized.

### Application Example 10

In the electronic device according to the application example of the invention, it is preferable that the functional element is a sensor element that outputs an electric signal due to strain.

With this configuration, detection sensitivity for pressure can be improved.

### Application Example 11

A physical quantity sensor according to this application example of the invention includes the electronic device according to the application example of the invention, wherein the substrate includes a diaphragm portion that is deflected and deformed under pressure, and the functional element is a sensor element.

According to the physical quantity sensor, the ceiling portion can be effectively reinforced with the reinforcing portion, so that damage caused by a difference in strength between the corner portion of the ceiling portion and a portion thereof adjacent to the corner portion can be reduced. Therefore, the physical quantity sensor according to the application example of the invention has excellent reliability.

### Application Example 12

A pressure sensor according to this application example of the invention includes the electronic device according to the application example of the invention.

With this configuration, it is possible to provide a pressure sensor having excellent reliability.

### Application Example 13

An altimeter according to this application example of the invention includes the electronic device according to the application example of the invention.

With this configuration, it is possible to provide an altimeter having excellent reliability.

### Application Example 14

An electronic apparatus according to this application example of the invention includes the electronic device according to the application example of the invention.

With this configuration, it is possible to provide an electronic apparatus having excellent reliability.

### Application Example 15

A moving object according to this application example of the invention includes the electronic device according to the application example of the invention.

With this configuration, it is possible to provide a moving object having excellent reliability.

### BRIEF DESCRIPTION OF THE DRAWINGS

The invention will be described with reference to the accompanying drawings, wherein like numbers reference like elements.

FIG. 1 is a cross-sectional view showing a physical quantity sensor (electronic device) according to a first embodiment of the invention.

FIG. 2 is a plan view showing the arrangement of piezoresistive elements (sensor elements) and a wall portion of the physical quantity sensor shown in FIG. 1.

FIGS. 3A and 3B are diagrams for explaining the operation of the physical quantity sensor shown in FIG. 1, in which FIG. 3A is a cross-sectional view showing a pressurized state and FIG. 3B is a plan view showing the pressurized state.

FIG. 4 is a plan view showing the arrangement of reinforcing portions (coupling portions) of the physical quantity sensor shown in FIG. 1.

FIG. 5 is a partially enlarged cross-sectional view of the physical quantity sensor shown in FIG. 1.

FIGS. 6A to 6D show manufacturing steps of the physical quantity sensor shown in FIG. 1.

FIGS. 7A to 7D show manufacturing steps of the physical quantity sensor shown in FIG. 1.

FIGS. 8A to 8C show manufacturing steps of the physical quantity sensor shown in FIG. 1.

FIG. 9 is a cross-sectional view showing a physical quantity sensor (electronic device) according to a second embodiment of the invention.

FIG. 10 is a cross-sectional view showing a physical quantity sensor (electronic device) according to a third embodiment of the invention.

FIG. 11 is a plan view showing the arrangement of reinforcing portions (coupling portions) of a physical quantity sensor (electronic device) according to a fourth embodiment of the invention.

FIG. 12 is a plan view showing the arrangement of reinforcing portions (coupling portions) of a physical quantity sensor (electronic device) according to a fifth embodiment of the invention.

FIG. 13 is a plan view showing the arrangement of reinforcing portions (coupling portions) of a physical quantity sensor (electronic device) according to a sixth embodiment of the invention.

FIG. 14 is a plan view showing the arrangement of reinforcing portions (coupling portions) of a physical quantity sensor (electronic device) according to a seventh embodiment of the invention.

FIG. 15 is a cross-sectional view showing an example of a pressure sensor according to the invention.

FIG. 16 is a perspective view showing an example of an altimeter according to the invention.

FIG. 17 is an elevation view showing an example of an electronic apparatus according to the invention.

FIG. 18 is a perspective view showing an example of a moving object according to the invention.

### DESCRIPTION OF EXEMPLARY EMBODIMENTS

Hereinafter, an electronic device, a physical quantity sensor, a pressure sensor, an altimeter, an electronic apparatus, and a moving object according to the invention will be described in detail based on embodiments shown in the accompanying drawings.

### 1. Physical Quantity Sensor

### First Embodiment

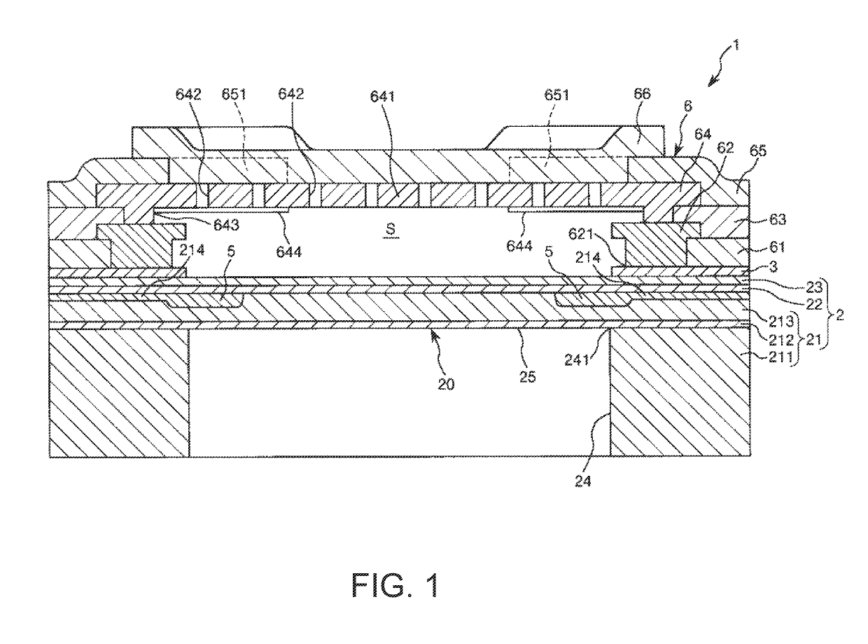

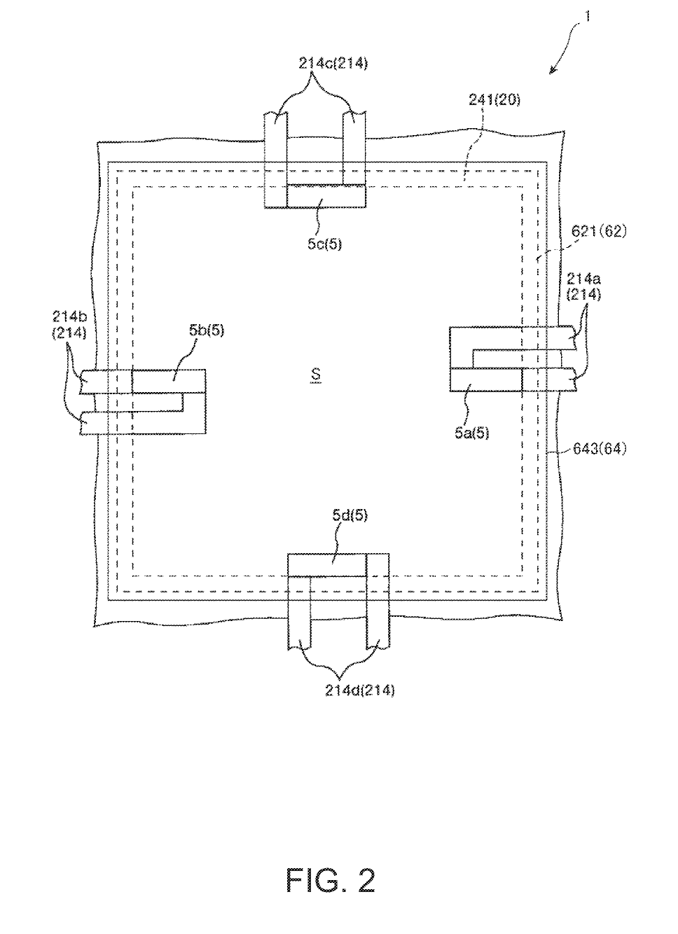

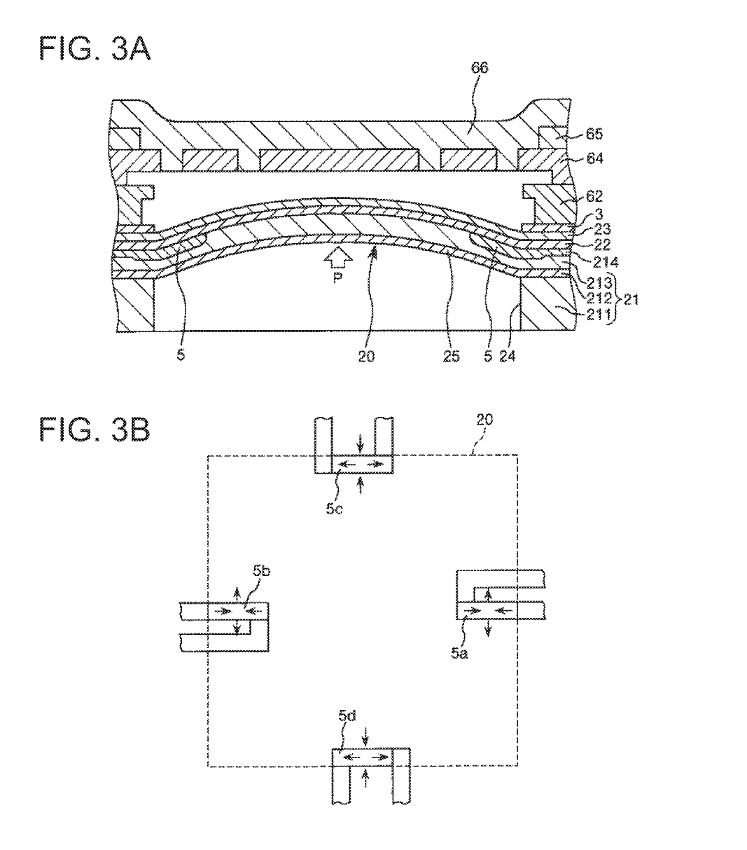

FIG. 1 is a cross-sectional view showing a physical quantity sensor according to a first embodiment of the invention. FIG. 2 is a plan view showing the arrangement of piezoresistive elements (sensor elements) and a wall portion of the physical quantity sensor shown in FIG. 1. FIGS. 3A and 3B are diagrams for explaining the operation of the physical quantity sensor shown in FIG. 1, in which FIG. 3A is a cross-sectional view showing a pressurized state and FIG. 3B is a plan view showing the pressurized state. In the following, the upper side in FIG. 1 is defined as “top”, and the lower side is defined as “bottom”, for convenience of description.

The physical quantity sensor 1 shown in FIG. 1 includes a substrate 2 including a diaphragm portion 20, a plurality of piezoresistive elements 5 (sensor elements) as functional elements disposed in the diaphragm portion 20, a stacked structure 6 forming a cavity S (interior space) together with the substrate 2, and an intermediate layer 3 disposed between the substrate 2 and the stacked structure 6.

Hereinafter, the parts constituting the physical quantity sensor 1 will be successively described.

### Substrate

The substrate 2 includes a semiconductor substrate 21, an insulating film 22 provided on one surface of the semiconductor substrate 21, and an insulating film 23 provided on a surface of the insulating film 22 on the side opposite to the semiconductor substrate 21.

The semiconductor substrate 21 is an SOI substrate in which a silicon layer 211 (handle layer) composed of single-crystal silicon, a silicon oxide layer 212 (BOX layer) composed of a silicon oxide film, and a silicon layer 213 (device layer) composed of single-crystal silicon are stacked in this order. The semiconductor substrate 21 is not limited to the SOI substrate, and may be another semiconductor substrate such as a single-crystal silicon substrate.

The insulating film 22 is, for example, a silicon oxide film, and has an insulating property. The insulating film 23 is, for example, a silicon nitride film, and has an insulating property and resistance to an etchant containing hydrofluoric acid. Here, since the insulating film 22 (silicon oxide film) lies between the semiconductor substrate 21 (the silicon layer 213) and the insulating film. 23 (silicon nitride film), the transfer of stress generated in deposition of the insulating film 23 to the semiconductor substrate 21 can be reduced by the insulating film 22. Moreover, the insulating film 22 can be used as a device isolation film when a semiconductor circuit is formed in and above the semiconductor substrate 21. The insulating films 22 and 23 are not limited to the constituent materials descried above. Moreover, any one of the insulating films 22 and 23 may be omitted as necessary.

The intermediate layer 3 that has been patterned is disposed on the insulating film 23 of the substrate 2. The intermediate layer 3 is formed so as to surround the diaphragm portion 20 in a plan view, and forms a step portion, which corresponds to the thickness of the intermediate layer 3, between the upper surface of the intermediate layer 3 and the upper surface of the substrate 2 and on the central side (inner side) of the diaphragm portion 20. With this configuration, when the diaphragm portion 20 is deflected and deformed under pressure, stress can be concentrated on a border portion of the diaphragm portion 20 relative to the step portion. Therefore, by disposing the piezoresistive elements 5 at the border portion (or near the border portion), detection sensitivity can be improved.

The intermediate layer 3 is composed of, for example, single-crystal silicon, polycrystalline silicon (polysilicon), or amorphous silicon. Moreover, the intermediate layer 3 may be formed by, for example, doping (diffusion or implantation) single-crystal silicon, polycrystalline silicon (polysilicon), or amorphous silicon with an impurity such as phosphorus or boron. In this case, since the intermediate layer 3 has conductivity, when, for example, a MOS transistor is formed on the substrate 2 outside the cavity S, a portion of the intermediate layer 3 can be used as a gate electrode of the MOS transistor. Moreover, a portion of the intermediate layer 3 can be used as a wire.

The substrate 2 is provided with the diaphragm portion 20, which is thinner than the surrounding portion thereof and deflected and deformed under pressure. The diaphragm portion 20 is formed by providing a bottomed recess 24 in the lower surface of the semiconductor substrate 21. That is, the diaphragm portion 20 is configured to include the bottom of the recess 24 opened in one surface of the substrate 2. The lower surface of the diaphragm portion 20 is a pressure receiving surface 25. In the embodiment, as shown in FIG. 2, the diaphragm portion 20 has a square (rectangular) plan-view shape.

In the substrate 2 of the embodiment, the recess 24 penetrates the silicon layer 211, and the diaphragm portion 20 is composed of four layers of the silicon oxide layer 212, the silicon layer 213, the insulating film 22, and the insulating film 23. Here, the silicon oxide layer 212 can be used as an etching stop layer in forming the recess 24 by etching in a manufacturing step of the physical quantity sensor 1 as will be described later, so that product-by-product variation in the thickness of the diaphragm portion 20 can be reduced.

The recess 24 may not penetrate the silicon layer 211, and the diaphragm portion 20 may be composed of five layers of a thin portion of the silicon layer 211, the silicon oxide layer 212, the silicon layer 213, the insulating film 22, and the insulating film 23.

### Piezoresistive Element (Functional Element)

As shown in FIG. 1, the plurality of piezoresistive elements 5 are formed on the cavity S side of the diaphragm portion 20. Here, the piezoresistive elements 5 are formed in the silicon layer 213 of the semiconductor substrate 21.

As shown in FIG. 2, the plurality of piezoresistive elements 5 are composed of a plurality of piezoresistive elements 5a, 5b, 5c, and 5d disposed at the perimeter portion of the diaphragm portion 20.

The piezoresistive element 5a, the piezoresistive element 5b, the piezoresistive element 5c, and the piezoresistive element 5d are disposed respectively corresponding to four sides of the diaphragm portion 20 having a quadrilateral shape in a plan view as viewed from a thickness direction of the substrate 2 (hereinafter simply referred to as “plan view”).

The piezoresistive element 5a extends along a direction vertical to the corresponding side of the diaphragm portion 20. A pair of wires 214a are electrically connected to both ends of the piezoresistive element 5a. Similarly, the piezoresistive element 5b extends along a direction vertical to the corresponding side of the diaphragm portion 20. A pair of wires 214b are electrically connected to both ends of the piezoresistive element 5b.

On the other hand, the piezoresistive element 5c extends along a direction parallel to the corresponding side of the diaphragm portion 20. A pair of wires 214c are electrically connected to both ends of the piezoresistive element 5c. Similarly, the piezoresistive element 5d extends along a direction parallel to the corresponding side of the diaphragm portion 20. A pair of wires 214d are electrically connected to both ends of the piezoresistive element 5d.

Hereinafter, the wires 214a, 214b, 214c, and 214d are also collectively referred to as “wire 214”.

The piezoresistive elements 5 and the wire 214 are composed of, for example, silicon (single-crystal silicon) doped (diffusion or implantation) with an impurity such as phosphorus or boron. Here, the doping concentration of impurity in the wire 214 is higher than the doping concentration of impurity in the piezoresistive element 5. The wire 214 may be composed of metal.

Moreover, the plurality of piezoresistive elements 5 are configured such that, for example, the resistance values thereof in a natural state are equal to each other.

The piezoresistive elements 5 described above constitute a bridge circuit (Wheatstone bridge circuit) via the wire 214 or the like. A driver circuit (not shown) that supplies a drive voltage is connected to the bridge circuit. The bridge circuit outputs a signal (voltage) in response to the resistance value of the piezoresistive elements 5.

### Stacked Structure

The stacked structure 6 is formed so as to define the cavity S between the stacked structure 6 and the substrate 2 described above. Here, the stacked structure 6 is disposed on the piezoresistive element 5 side of the diaphragm portion 20, and defines and forms (constitutes) the cavity S (interior space) together with the diaphragm portion 20 (or the substrate 2).

The stacked structure 6 includes an inter-layer insulating film 61 formed on the substrate 2 so as to surround the piezoresistive elements 5 in the plan view, a wiring layer 62 formed on the inter-layer insulating film 61, an inter-layer insulating film 63 formed on the wiring layer 62 and the inter-layer insulating film 61, a wiring layer 64 formed on the inter-layer insulating film 63 and including a covering layer 641 provided with a plurality of fine pores 642 (openings), a surface protective film 65 formed on the wiring layer 64 and the inter-layer insulating film 63, and a sealing layer 66 provided on the covering layer 641.

The inter-layer insulating films 61 and 63 are each composed of, for example, a silicon oxide film. The wiring layers 62 and 64 and the sealing layer 66 are each composed of metal such as aluminum. The sealing layer 66 seals the plurality of fine pores 642 of the covering layer 641. The surface protective film 65 is, for example, a silicon nitride film.

In the stacked structure 6, a structure formed of the wiring layer 62 and the wiring layer 64 except for the covering layer 641 constitutes “wall portion” that is disposed to surround the piezoresistive elements 5, in the plan view, on one surface side of the substrate 2. The covering layer 641 is disposed on the side opposite to the substrate 2 with respect to the wall portion, and constitutes “ceiling portion” that constitutes the cavity S (interior space) together with the wall portion. The wiring layer 64 includes four reinforcing portions 644 that reinforce the covering layer 641. The surface protective film 65 includes four reinforcing portions 651 that reinforce the covering layer 641. The reinforcing portions 644 and 651 and matters relating to the reinforcing portions will be described in detail later.

The stacked structure 6 can be formed using a semiconductor manufacturing process such as a CMOS process. A semiconductor circuit may be fabricated on and above the silicon layer 213. The semiconductor circuit includes active elements, such as MOS transistors, and other circuit elements formed as necessary, such as capacitors, inductors, resistors, diodes, and wires (including the wires connected to the piezoresistive elements 5).

The cavity S defined by the substrate 2 and the stacked structure 6 is a hermetically sealed space. The cavity S functions as a pressure reference chamber providing a reference value of pressure that the physical quantity sensor 1 detects. In the embodiment, the cavity S is in a vacuum state (300 Pa or less). By setting the cavity S into the vacuum state, the physical quantity sensor 1 can be used as an “absolute pressure sensor” that detects pressure with the vacuum state as a reference, so that the convenience of the physical quantity sensor 1 is improved.

However, the cavity S may not be in the vacuum state. The cavity S may be in an atmospheric pressure, a reduced-pressure state where the air pressure is lower than the atmospheric pressure, or a pressurized state where the air pressure is higher than the atmospheric pressure. Moreover, an inert gas such as nitrogen gas or noble gas may be sealed in the cavity S.

The configuration of the physical quantity sensor 1 has been briefly described above.

In the physical quantity sensor 1 having the configuration described above, the diaphragm portion 20 is deformed in response to pressure P received by the pressure receiving surface 25 of the diaphragm portion 20 as shown in FIG. 3A, whereby the piezoresistive elements 5a, 5b, 5c, and 5d strain as shown in FIG. 3B and thus the resistance values of the piezoresistive elements 5a, 5b, 5c, and 5d change. With the change, an output of the bridge circuit composed of the piezoresistive elements 5a, 5b, 5c, and 5d changes, and based on the output, the magnitude of the pressure received by the pressure receiving surface 25 can be obtained.

More specifically, in the natural state prior to the occurrence of deformation of the diaphragm portion 20 described above, when the resistance values of the piezoresistive elements 5a, 5b, 5c, and 5d are equal to each other for example, the product of the resistance values of the piezoresistive elements 5a and 5b is equal to the product of the resistance values of the piezoresistive elements 5c and 5d, so that the output (potential difference) of the bridge circuit is zero.

On the other hand, when the deformation of the diaphragm portion 20 occurs as described above, a compressive strain along a longitudinal direction of the piezoresistive elements 5a and 5b and a tensile strain along a width direction thereof occur in the piezoresistive elements 5a and 5b as shown in FIG. 3B, and at the same time, a tensile strain along a longitudinal direction of the piezoresistive elements 5c and 5d and a compressive strain along a width direction thereof occur in the piezoresistive elements 5c and 5d. Hence, when the deformation of the diaphragm portion 20 occurs as described above, either the resistance values of the piezoresistive elements 5a and 5b or the resistance values of the piezoresistive elements 5c and 5d increase, and the other resistance values decrease.

Due to the strain of the piezoresistive elements 5a, 5b, 5c, and 5d, a difference occurs between the product of the resistance values of the piezoresistive elements 5a and 5b and the product of the resistance values of the piezoresistive elements 5c and 5d, so that an output (potential difference) according to the difference is output from the bridge circuit. Based on the output from the bridge circuit, the magnitude of the pressure (absolute pressure) received by the pressure receiving surface 25 can be obtained.

Here, when the deformation of the diaphragm portion 20 occurs as described above, either the resistance values of the piezoresistive elements 5a and 5b or the resistance values of the piezoresistive elements 5c and 5d increase, and the other resistance values decrease. Therefore, a change in the difference between the product of the resistance values of the piezoresistive elements 5a and 5b and the product of the resistance values of the piezoresistive elements 5c and 5d can be increased, and with the increase, the output from the bridge circuit can be increased. As a result, detection sensitivity for pressure can be enhanced.

As described above, in the physical quantity sensor 1, the diaphragm portion 20 of the substrate 2 is provided at a position overlapping the covering layer 641 in the plan view, and is deflected and deformed under pressure. With this configuration, the physical quantity sensor 1 capable of detecting pressure can be realized. Moreover, since the piezoresistive element 5 disposed in the diaphragm portion 20 is a sensor element that outputs an electric signal due to strain, the detection sensitivity for pressure can be improved. Moreover, since the outline of the diaphragm portion 20 is rectangular in the plan view as described above, the detection sensitivity for pressure can be improved.

### Reinforcing Portion

Hereinafter, the reinforcing portions 644 and 651 will be described in detail.

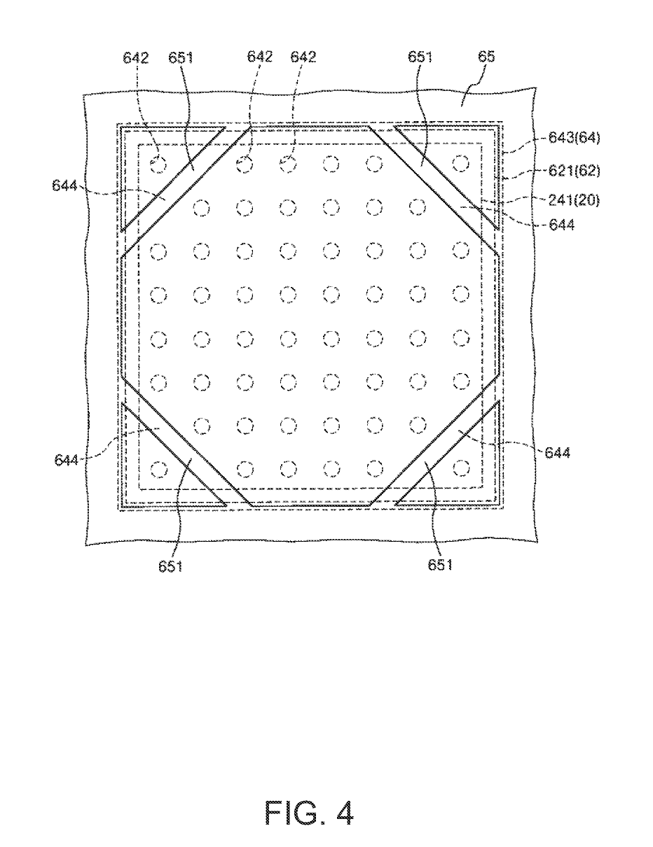

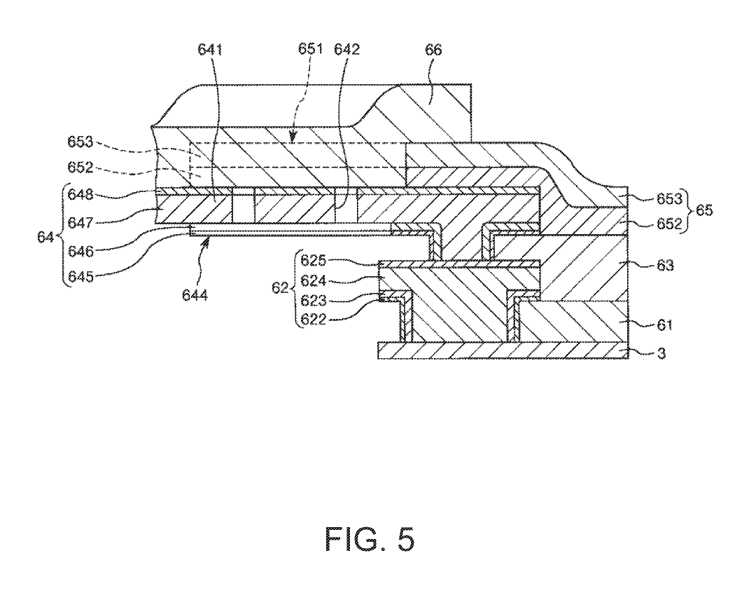

FIG. 4 is a plan view showing the arrangement of the reinforcing portions of the physical quantity sensor shown in FIG. 1. FIG. 5 is a partially enlarged cross-sectional view of the physical quantity sensor shown in FIG. 1.

As described above, the wiring layer 64 includes the four reinforcing portions 644 that reinforce the covering layer 641, and the surface protective film 65 includes the four reinforcing portions 651 that reinforce the covering layer 641.

Here, as shown in FIG. 4, the covering layer 641 is rectangular in the plan view, and includes four corner portions each configured to include two sides adjacent to each other. Each of the reinforcing portions 644 and each of the reinforcing portions 651 are disposed to couple the two sides adjacent to each other. Therefore, the reinforcing portion can also be expressed as “coupling portion”. With this configuration, the covering layer 641 can be effectively reinforced with the reinforcing portions 644 and 651, so that damage caused by a difference in strength between the corner portion of the covering layer 641 and a portion thereof adjacent to the corner portion can be reduced. Therefore, the physical quantity sensor 1 according to the invention has excellent reliability.

In contrast, if both the reinforcing portions 644 and the reinforcing portions 651 are omitted, the strength of a portion corresponding to the corner portion of the covering layer 641 is extremely high compared to that of other portions. Therefore, when the thermal shrinkage or the like of the covering layer 641 occurs, stress is likely to be concentrated on a portion between the portion corresponding to the corner portion of the covering layer 641 and other portions. As a result, damage such as a crack is likely to occur to the covering layer 641.

Moreover, the reinforcing portions 644 are located on the cavity S side of the covering layer 641. With this configuration, a reinforcing effect of the reinforcing portions 644 can be made excellent. Moreover, when the wiring layer 64 is formed using a photolithographic technique and an etching technique as will be described later, the reinforcing portions 644 can be formed using an antireflection film used in photolithographic exposure, and thus the manufacturing step can be simplified.

In the embodiment, as shown in FIG. 5, the wiring layer 62 includes a Ti layer 622 composed of titanium (Ti), a TiN layer 623 composed of titanium nitride (TiN), an Al layer 624 composed of aluminum (Al), and a TiN layer 625 composed of titanium nitride (TiN), which are stacked in this order. Similarly, the wiring layer 64 includes a Ti layer 645 composed of titanium (Ti), a TiN layer 646 composed of titanium nitride (TiN), an Al layer 647 composed of aluminum (Al), and a TiN layer 648 composed of titanium nitride (TiN), which are stacked in this order.

The reinforcing portion 644 is composed of a portion of the Ti layer 645 and a portion of the TiN layer 646. The TiN layer 646 is a portion of the antireflection film used in photolithographic exposure, and is formed using the antireflection film.

Moreover, since the reinforcing portion 644 contains titanium nitride, a difference in thermal expansion between the covering layer 641 and the reinforcing portion 644 can be reduced when the covering layer 641 is configured using aluminum. Therefore, when thermal shrinkage or the like occurs in the covering layer 641, stress concentration occurring in the covering layer 641 can be reduced, and thus damage to the covering layer 641 can be reduced.

Moreover, since the reinforcing portion 644 contains a material with a lower thermal expansion rate than that of the covering layer 641, the thermal shrinkage or thermal expansion of the covering layer 641 can be reduced.

On the other hand, the reinforcing portions 651 are located on the side of the covering layer 641 opposite to the cavity S. With this configuration, the reinforcing portions 651 and the surface protective film 65 can be formed collectively, so that the manufacturing step can be simplified.

In the embodiment, as shown in FIG. 5, the surface protective film 65 includes a SiO₂ layer 652 as a first layer composed of silicon oxide (SiO₂), and a SiN layer 653 as a second layer disposed on the side opposite to the cavity S with respect to the SiO₂ and composed of silicon nitride (SiN). The reinforcing portion 651 is composed of a portion of the SiO₂ layer 652 and a portion of the SiN layer 653. With this configuration, the reinforcing portions 651 and the surface protective film 65 can be formed collectively.

Moreover, since the reinforcing portion 651 contains a material with a lower thermal expansion rate than that of the covering layer 641, the thermal shrinkage or thermal expansion of the covering layer 641 can be reduced.

As described above, in the embodiment, the reinforcing portions 644 are located on one surface side of the covering layer 641, and the reinforcing portions 651 are located on the other surface side. That is, the covering layer 641 is located between the reinforcing portions 644 and the reinforcing portions 651. With this configuration, the reinforcing effect of the reinforcing portions 644 and 651 can be made excellent while simplifying the manufacturing step. Here, the reinforcing portions 644 constitute “first coupling portion”, and the reinforcing portions 651 constitute “second coupling portion” disposed on the side opposite to the cavity S (interior space) with respect to the reinforcing portions 644 (the first coupling portion).

Moreover, each of the reinforcing portions 644 and 651 has a shape extending in a direction inclined to adjacent two sides of the covering layer 641 having a rectangular shape in the plan view. With this configuration, the mass of a structure formed of the covering layer 641 and the reinforcing portions 644 and 651 can be reduced, and the deflection of the covering layer 641 can be reduced. Therefore, damage to the covering layer 641 can be reduced more effectively. Moreover, the arrangement density of the plurality of fine pores 642 of the wiring layer 64 can be increased. Therefore, etching through the fine pores 642 can be efficiently performed in a manufacturing step described later.

Here, the fine pores 642 are disposed so as not to overlap the reinforcing portions 644 and 651 in the plan view and so as to disperse over a range as wide as possible. In particular, the plurality of fine pores 642 are disposed such that the fine pore 642 is present also at a position near the corner portion of the covering layer 641 in the plan view. With this configuration, etching through the fine pores 642 can be efficiently performed in the manufacturing step described later.

### Method for Manufacturing Physical Quantity Sensor

Next, a method for manufacturing the physical quantity sensor 1 will be briefly described.

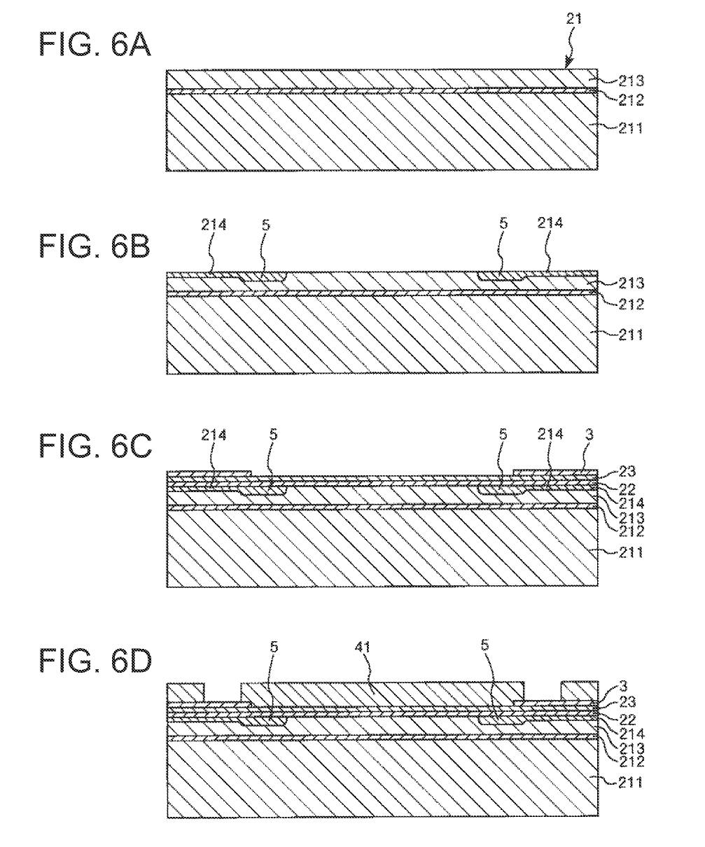

FIGS. 6A to 8C show manufacturing steps of the physical quantity sensor shown in FIG. 1. Hereinafter, the method for manufacturing the physical quantity sensor 1 will be described based on the drawings.

### Step of Forming Elements

First, as shown in FIG. 6A, the semiconductor substrate 21 as an SOI substrate is prepared.

By doping (ion implantation) the silicon layer 213 of the semiconductor substrate 21 with an impurity such as phosphorus (n type) or boron (p type), the plurality of piezoresistive elements 5 and the wire 214 are formed as shown in FIG. 6B.

For example, when ion implantation with boron at +80 keV is performed, the concentration of ion implantation into the piezoresistive element 5 is set to about 1×10¹⁴ atoms/cm². Moreover, the concentration of ion implantation into the wire 214 is set to be greater than that into the piezoresistive element 5. For example, when ion implantation with boron at 10 keV is performed, the concentration of ion implantation into the wire 214 is set to about 5×10¹⁵ atoms/cm². Moreover, after the ion implantation described above, annealing is performed at, for example, about 1000° C. for about 20 minutes.

### Step of Forming Insulating Films, Etc.

Next, as shown in FIG. 6C, the insulating film 22, the insulating film 23, and the intermediate layer 3 are formed in this order on the silicon layer 213.

The formation of each of the insulating films 22 and 23 can be performed by, for example, a sputtering method, a CVD method, or the like. The intermediate layer 3 can be formed by, for example, depositing polycrystalline silicon by a sputtering method, a CVD method, or the like, then doping (ion implantation) the deposited film with an impurity such as phosphorus or boron as necessary, and thereafter patterning the film by etching.

### Step of Forming Inter-Layer Insulating Films and Wiring Layers

Next, as shown in FIG. 6D, a sacrificial layer 41 is formed on the insulating film 23.

The sacrificial layer 41 is a layer a portion of which is removed by a step of forming the cavity described later and the rest of which serves as the inter-layer insulating film 61, and has a through-hole through which the wiring layer 62 penetrates. The formation of the sacrificial layer 41 is performed by forming a silicon oxide film by a sputtering method, a CVD method, or the like, and patterning the silicon oxide film by etching.

The thickness of the sacrificial layer 41 is not particularly limited but set to, for example, about from 1500 nm to 5000 nm.

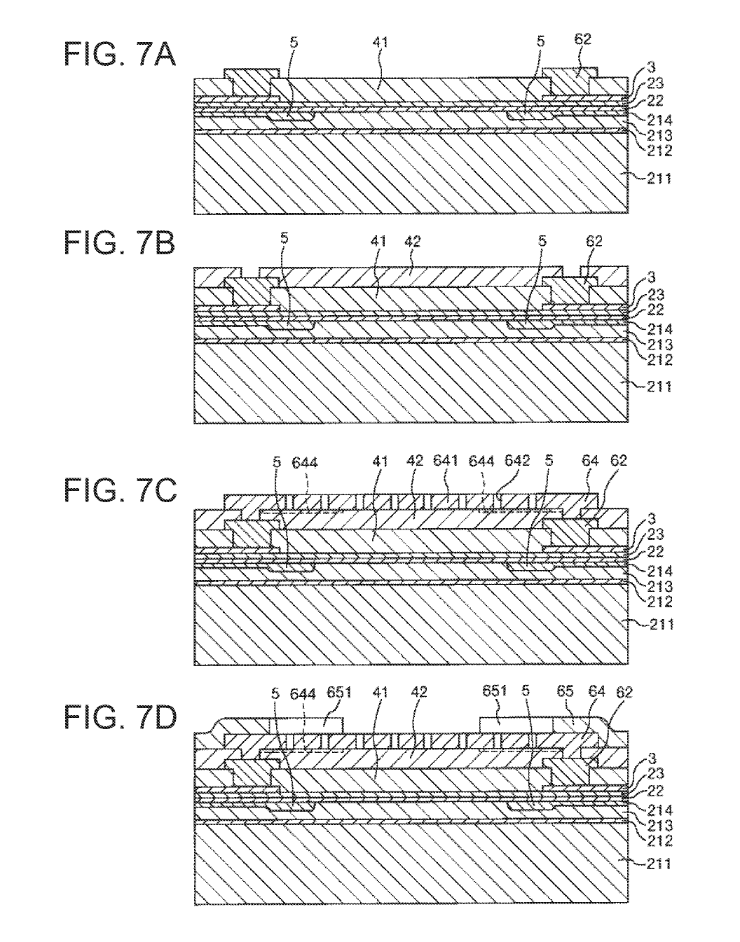

Next, as shown in FIG. 7A, the wiring layer 62 is formed so as to fill the through-hole formed in the sacrificial layer 41.

The formation of the wiring layer 62 can be performed by, for example, forming a uniform conductor film by a sputtering method, a CVD method, or the like, and then processing the conductor film by patterning. Although not shown in the drawing, in forming the wiring layer 62 including the Ti layer 622, the TiN layer 623, the Al layer 624, and the TiN layer 625 described above, the Ti layer 622 and the TiN layer 623 are formed by uniformly forming a Ti layer and a TiN layer in this order and then patterning the layers, and thereafter, the Al layer 624 and the TiN layer 625 are formed by uniformly forming an Al layer and a TiN layer in this order and then patterning the layers. Here, the TiN layer 623 has a function of enhancing the wettability of Al in order to make the filling of Al into the through-hole of the sacrificial layer 41 favorable, while the Ti layer 622 has a function of enhancing the adhesion between the TiN layer 623 and the sacrificial layer 41. The TiN layer uniformly formed on the Al layer functions as an antireflection film that prevents the reflection of photolithographic exposure light in forming the Al layer 624 and the TiN layer 625 by patterning.

The thickness of the wiring layer 62 is not particularly limited but set to, for example, about from 300 nm to 900 nm.

Next, as shown in FIG. 7B, a sacrificial layer 42 is formed on the sacrificial layer 41 and the wiring layer 62.

The sacrificial layer 42 is a layer a portion of which is removed by the step of forming the cavity described later and the rest of which serves as the inter-layer insulating film 63, and has a through-hole through which the wiring layer 64 penetrates. The formation of the sacrificial layer 42 is performed by, similarly to the formation of the sacrificial layer 41 described above, forming a silicon oxide film by a sputtering method, a CVD method, or the like, and patterning the silicon oxide film by etching.

The thickness of the sacrificial layer 42 is not particularly limited but set to, for example, about from 1500 nm to 5000 nm.

Next, as shown in FIG. 7C, the wiring layer 64 is formed so as to fill the through-hole formed in the sacrificial layer 42.

The formation of the wiring layer 64 can be performed by, for example, forming a uniform conductor film by a sputtering method, a CVD method, or the like, and then processing the conductor film by patterning. Although not shown in the drawing, in forming the wiring layer 64 including the Ti layer 645, the TiN layer 646, the Al layer 647, and the TiN layer 648 described above, the Ti layer 645 and the TiN layer 646 are formed by uniformly forming a Ti layer and a TiN layer in this order and then patterning the layers, and thereafter, the Al layer 647 and the TiN layer 648 are formed by uniformly forming an Al layer and a TiN layer in this order and then patterning the layers. Here, the TiN layer 646 has a function of enhancing the wettability of Al in order to make the filling of Al into the through-hole of the sacrificial layer 42 favorable, while the Ti layer 645 has a function of enhancing the adhesion between the TiN layer 646 and the sacrificial layer 42. The TiN layer uniformly formed on the Al layer functions as an antireflection film that prevents the reflection of photolithographic exposure light in forming the Al layer 647 and the TiN layer 648 by patterning.

The thickness of the wiring layer 64 is not particularly limited but set to, for example, about from 300 nm to 900 nm.

As described above, the sacrificial layers 41 and 42 and the wiring layers 62 and 64 are formed. A stacked structure formed of the sacrificial layers 41 and 42 and the wiring layers 62 and 64 is formed using a normal CMOS process, and the number of stacked layers is appropriately set as necessary. That is, still more sacrificial layers or wiring layers may be stacked as necessary.

Thereafter, as shown in FIG. 7D, the surface protective film 65 is formed by a sputtering method, a CVD method, or the like. With this configuration, the portions of the sacrificial layers 41 and 42, which serve as the inter-layer insulating films 61 and 62, can be protected in etching in the step of forming the cavity described later.

Although not shown in the drawing, in forming the surface protective film 65 including the SiO₂ layer 652 and the SiN layer 653 described above, the SiO₂ layer 652 and the SiN layer 653 are formed by uniformly forming a SiO₂ layer and a SiN layer in this order and then patterning the layers.

The configuration of the surface protective film 65 is not limited to that described above. Examples of the constituent material of the surface protective film 65 include, for example, a film having resistance for protecting the element from moisture, dust, flaw, or the like, such as a silicon oxide film, a silicon nitride film, a polyimide film, or an epoxy resin film, and in particular, a silicon nitride film is suitably used.

The thickness of the surface protective film 65 is not particularly limited but set to, for example, about from 500 nm to 2000 nm.

### Step of Forming Cavity

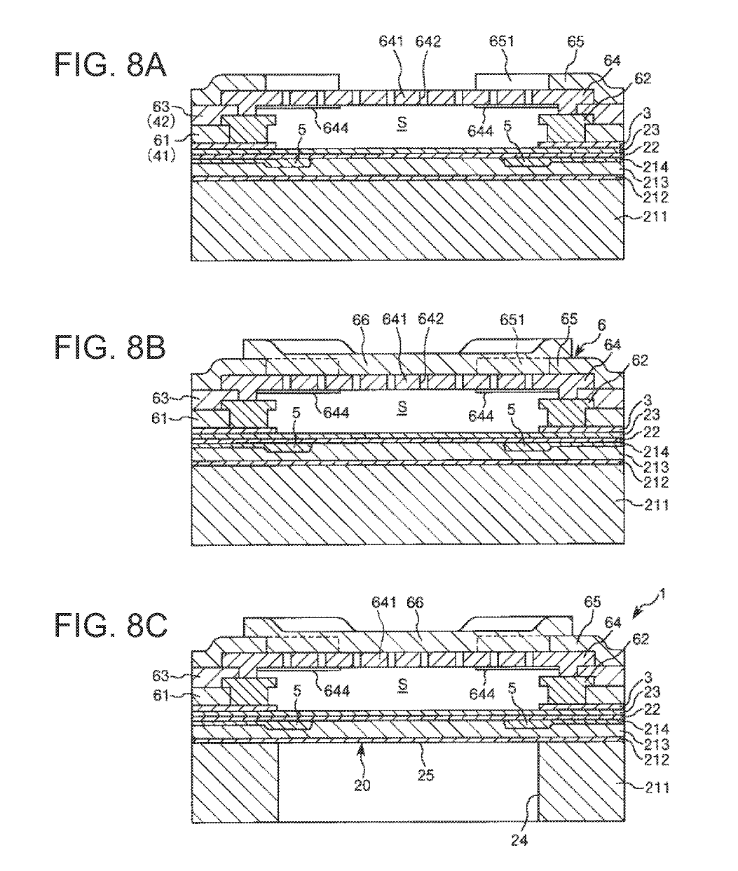

Next, as shown in FIG. 8A, the cavity S is formed between the insulating film 23 and the covering layer 641 by removing portions of the sacrificial layers 41 and 42. With this configuration, the inter-layer insulating films 61 and 63 are formed.

The formation of the cavity S is performed by removing the portions of the sacrificial layers 41 and 42 by etching through the plurality of fine pores 642 formed in the covering layer 641. Here, when wet etching is used as the etching, an etchant such as hydrofluoric acid or buffered hydrofluoric acid is supplied through the plurality of fine pores 642; while when dry etching is used, an etching gas such as hydrofluoric acid gas is supplied through the plurality of fine pores 642. In the etching, the insulating film 23 functions as an etching stop layer. Moreover, since the insulating film 23 has resistance to an etchant, the insulating film 23 also has a function of protecting the constituent portion (e.g., the insulating film 22, the piezoresistive elements 5, the wire 214, etc.) below the insulating film 23 from the etchant.

### Step of Sealing

Next, as shown in FIG. 8B, the sealing layer 66 formed of a silicon oxide film, a silicon nitride film, or a metal film such as of Al, Cu, W, Ti, or TiN is formed on the covering layer 641 by a sputtering method, a CVD method, or the like to seal the fine pores 642. With this configuration, the cavity S is sealed by the sealing layer 66, so that the stacked structure 6 is obtained.

Here, the thickness of the sealing layer 66 is not particularly limited but set to, for example, about from 1000 nm to 5000 nm.

### Step of Forming Diaphragm

Next, after the lower surface of the silicon layer 211 is ground as necessary, the recess 24 is formed by removing (processing) a portion of the lower surface of the silicon layer 211 by etching as shown in FIG. 8C. With this configuration, the diaphragm portion 20 facing the covering layer 641 via the cavity S is formed.

Here, in removing a portion of the lower surface of the silicon layer 211, the silicon oxide layer 212 functions as an etching stop layer. With this configuration, the thickness of the diaphragm portion 20 can be defined with high accuracy.

The method of removing a portion of the lower surface of the silicon layer 211 may be dry etching, wet etching, or the like.

Through the steps described above, the physical quantity sensor 1 can be manufactured.

### Second Embodiment

Next, a second embodiment of the invention will be described.

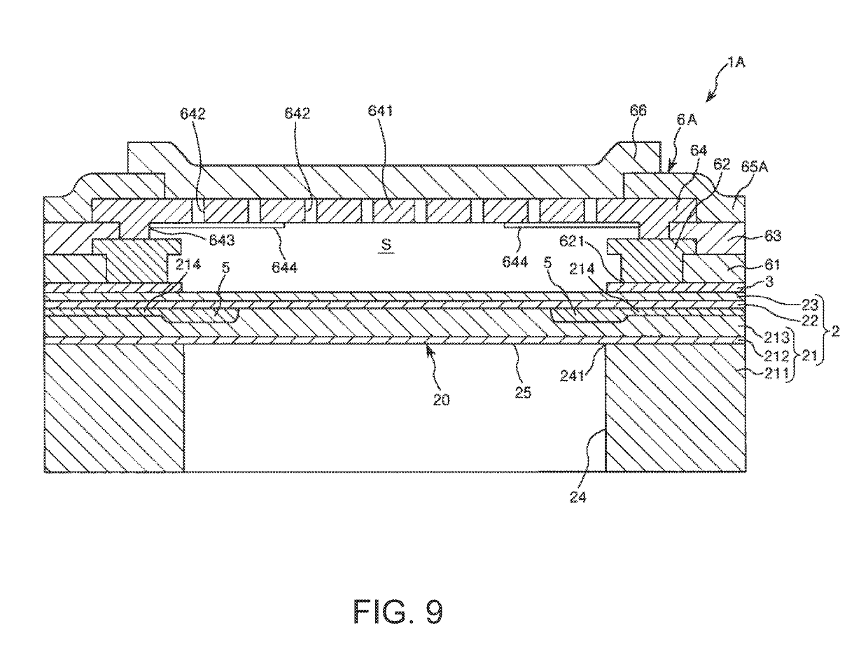

FIG. 9 is a cross-sectional view showing a physical quantity sensor (electronic device) according to a second embodiment of the invention.

Hereinafter, the second embodiment of the invention will be described, in which differences from the embodiment described above are mainly described and the description of similar matters is omitted.

The second embodiment is similar to the first embodiment described above, except that the reinforcing portions on the side opposite to the interior space with respect to the ceiling portion are omitted.

The physical quantity sensor 1A shown in FIG. 9 includes a stacked structure 6A that forms the cavity S (interior space) together with the substrate 2. The stacked structure 6A is similar to the stacked structure 6 of the first embodiment described above, except that a surface protective film 65A is included instead of the surface protective film 65. Moreover, the surface protective film 65A is similar to the surface protective film 65 of the first embodiment described above, except that the reinforcing portions 651 are omitted.

According also to the physical quantity sensor 1A, the covering layer 641 can be effectively reinforced with the reinforcing portions 644, so that damage caused by a difference in strength between the corner portion of the covering layer 641 and a portion thereof adjacent to the corner portion can be reduced.

### Third Embodiment

Next, a third embodiment of the invention will be described.

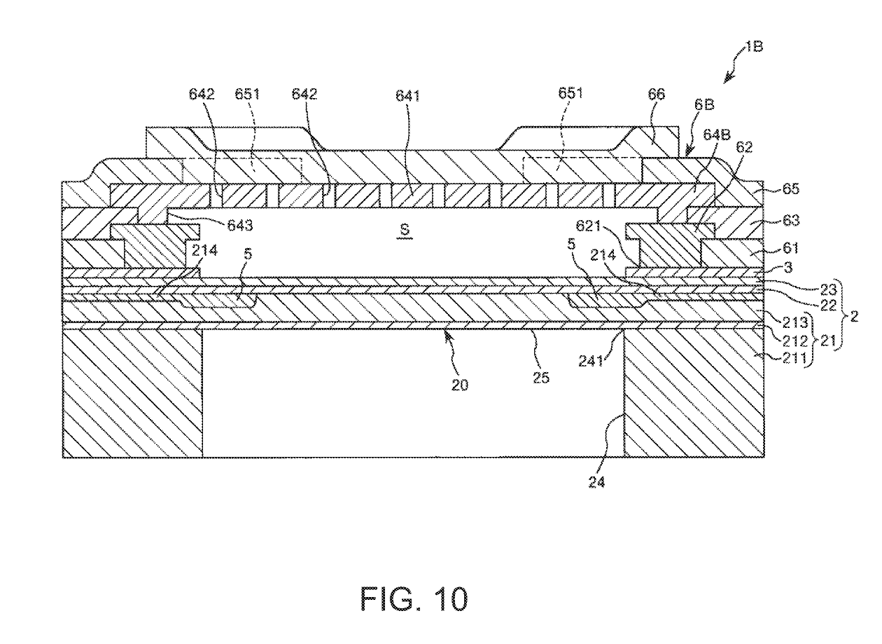

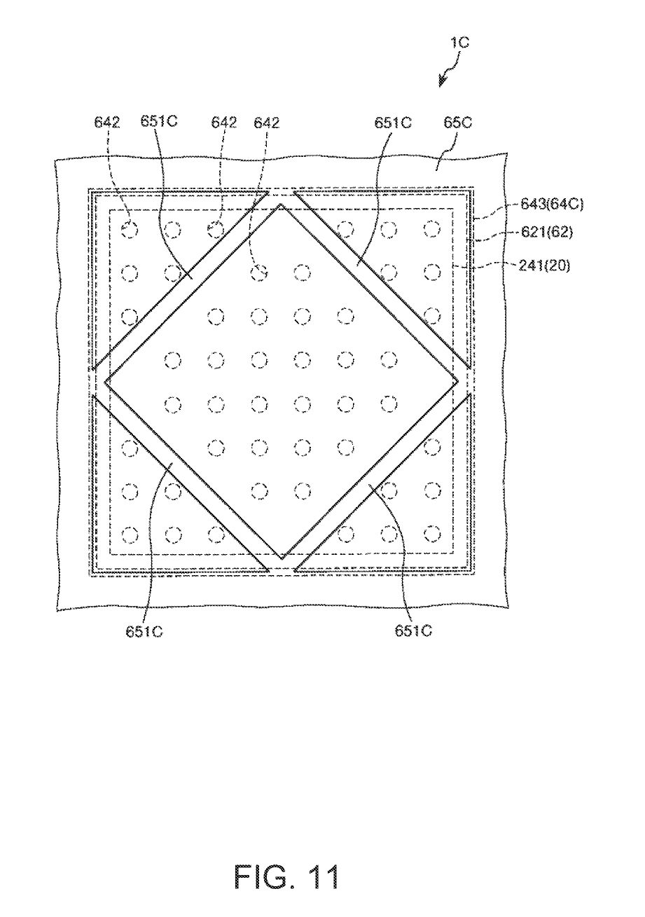

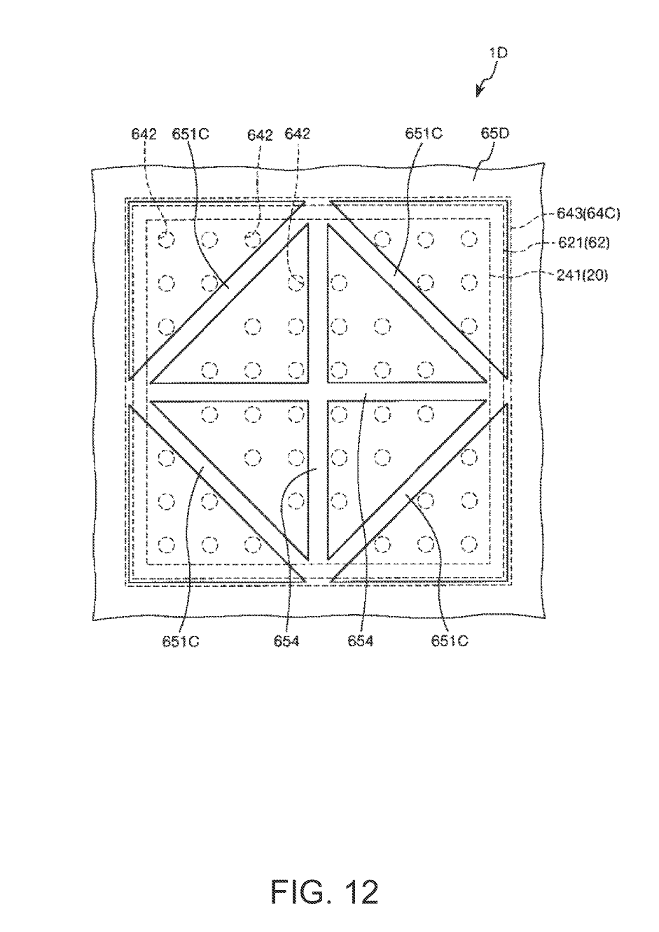

FIG. 10 is a cross-sectional view showing a physical quantity sensor (electronic device) according to the third embodiment of the invention.

Hereinafter, the third embodiment of the invention will be described, in which differences from the embodiments described above are mainly described and the description of similar matters is omitted.

The third embodiment is similar to the first embodiment described above, except that the reinforcing portions on the interior space side with respect to the ceiling portion are omitted.

The physical quantity sensor 1B shown in FIG. 10 includes a stacked structure 6B that forms the cavity S (interior space) together with the substrate 2. The stacked structure 6B is similar to the stacked structure 6 of the first embodiment described above, except that a wiring layer 64B is included instead of the wiring layer 64. Moreover, the wiring layer 64B is similar to the wiring layer 64 of the first embodiment described above, except that the reinforcing portions 644 are omitted.

According also to the physical quantity sensor 1B, the covering layer 641 can be effectively reinforced with the reinforcing portions 651, so that damage caused by a difference in strength between the corner portion of the covering layer 641 and a portion thereof adjacent to the corner portion can be reduced.

### Fourth Embodiment

Next, a fourth embodiment of the invention will be described.

FIG. 11 is a plan view showing the arrangement of reinforcing portions of a physical quantity sensor (electronic device) according to the fourth embodiment of the invention.

Hereinafter, the fourth embodiment of the invention will be described, in which differences from the embodiments described above are mainly described and the description of similar matters is omitted.

The fourth embodiment is similar to the first embodiment described above, except that the arrangement of the reinforcing portions is different.

The physical quantity sensor 1C shown in FIG. 11 includes a surface protective film 65C including four reinforcing portions 651C. Each of the reinforcing portions 651C extends from the middle portion of each side of the covering layer having a rectangular shape in the plan view. With this configuration, the arrangement density of the fine pores 642 of a wiring layer 64C can be effectively increased at a position near the corner portion of the covering layer 641.

According also to the physical quantity sensor 1C, the covering layer can be effectively reinforced with the reinforcing portions 651C, so that damage caused by a difference in strength between the corner portion of the covering layer and a portion thereof adjacent to the corner portion can be reduced.

### Fifth Embodiment

Next, a fifth embodiment of the invention will be described.

FIG. 12 is a plan view showing the arrangement of reinforcing portions of a physical quantity sensor (electronic device) according to the fifth embodiment of the invention.

Hereinafter, the fifth embodiment of the invention will be described, in which differences from the embodiments described above are mainly described and the description of similar matters is omitted.

The fifth embodiment is similar to the first embodiment described above, except that the arrangement of the reinforcing portions is different.

The physical quantity sensor 1D shown in FIG. 12 includes a surface protective film 65D including the four reinforcing portions 651C and two reinforcing portions 654. Each of the reinforcing portions 654 couples together the middle portions of two facing sides of the covering layer having a rectangular shape in the plan view, and the two reinforcing portions 654 intersect and connect with each other at the middle portions thereof.

According also to the physical quantity sensor 1D, the covering layer can be effectively reinforced with the reinforcing portions 651C and 654, so that damage caused by a difference in strength between the corner portion of the covering layer and a portion thereof adjacent to the corner portion can be reduced.

### Sixth Embodiment

Next, a sixth embodiment of the invention will be described.

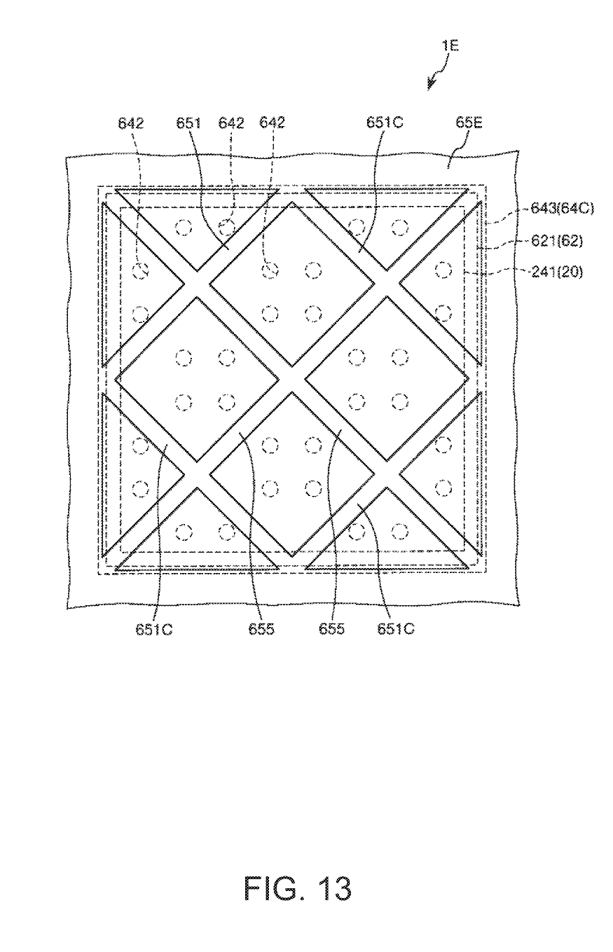

FIG. 13 is a plan view showing the arrangement of reinforcing portions of a physical quantity sensor (electronic device) according to the sixth embodiment of the invention.

Hereinafter, the sixth embodiment of the invention will be described, in which differences from the embodiments described above are mainly described and the description of similar matters is omitted.

The sixth embodiment is similar to the first embodiment described above, except that the arrangement of the reinforcing portions is different.

The physical quantity sensor 1E shown in FIG. 13 includes a surface protective film 65E including the four reinforcing portions 651C and two reinforcing portions 655. Each of the reinforcing portions 655 couples together two facing corner portions of the covering layer having a rectangular shape in the plan view, and the two reinforcing portions 655 intersect and connect with each other at the middle portions thereof.

According also to the physical quantity sensor 1E, the covering layer can be effectively reinforced with the reinforcing portions 651C and 655, so that damage caused by a difference in strength between the corner portion of the covering layer and a portion thereof adjacent to the corner portion can be reduced.

### Seventh Embodiment

Next, a seventh embodiment of the invention will be described.

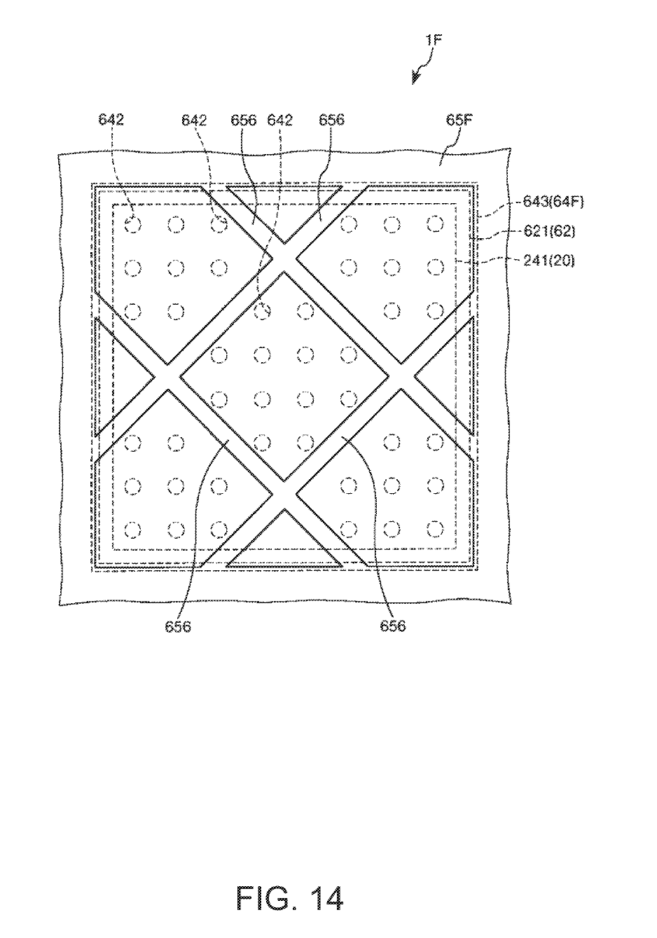

FIG. 14 is a plan view showing the arrangement of reinforcing portions of a physical quantity sensor (electronic device) according to the seventh embodiment of the invention.

Hereinafter, the seventh embodiment of the invention will be described, in which differences from the embodiments described above are mainly described and the description of similar matters is omitted.

The seventh embodiment is similar to the first embodiment described above, except that the arrangement of the reinforcing portions is different.

The physical quantity sensor 1F shown in FIG. 14 includes a surface protective film 65F including four reinforcing portions 656. Each of the reinforcing portions 656 couples two adjacent sides of the covering layer having a rectangular shape in the plan view. In particular, each of the reinforcing portions 656 extends from the side of one of the two adjacent sides of the covering layer in the plan view distant from the other side toward the other side. Therefore, one reinforcing portion 656 intersects and connects with another reinforcing portion 656 that extends from the same side, along the way.

According also to the physical quantity sensor 1F, the covering layer can be effectively reinforced with the reinforcing portions 656, so that damage caused by a difference in strength between the corner portion of the covering layer and a portion thereof adjacent to the corner portion can be reduced.

### 2. Pressure Sensor

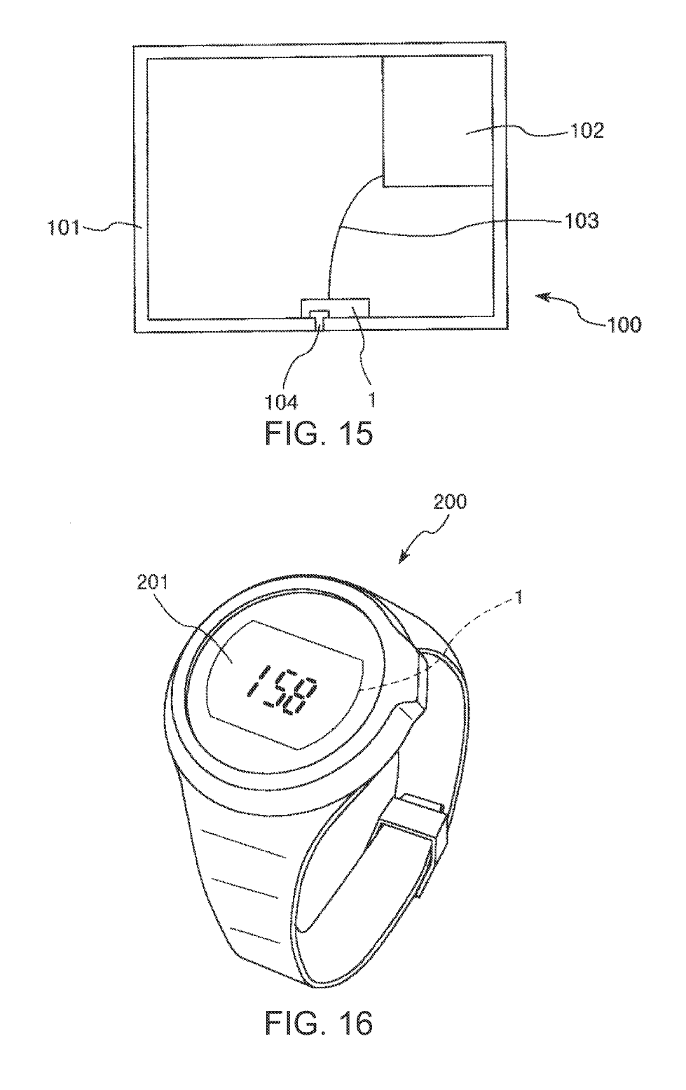

Next, a pressure sensor (pressure sensor according to the invention) including the physical quantity sensor according to the invention will be described. FIG. 15 is a cross-sectional view showing an example of the pressure sensor according to the invention.

As shown in FIG. 15, a pressure sensor 100 according to the invention includes the physical quantity sensor 1, a housing 101 that accommodates the physical quantity sensor 1, and an arithmetic portion 102 that calculates pressure data from a signal obtained from the physical quantity sensor 1. The physical quantity sensor 1 is electrically connected with the arithmetic portion 102 via a wire 103.

The physical quantity sensor 1 is fixed inside the housing 101 by a fixing unit (not shown). The housing 101 includes a through-hole 104 for the diaphragm portion 20 of the physical quantity sensor 1 to communicate with, for example, the atmosphere (the outside of the housing 101).

According to the pressure sensor 100, the diaphragm portion 20 receives pressure through the through-hole 104. The signal of the received pressure is transmitted to the arithmetic portion via the wire 103 to calculate the pressure data. The calculated pressure data can be displayed through a display portion (e.g., a monitor of a personal computer, etc.) (not shown).

### 3. Altimeter

Next, an example of an altimeter (altimeter according to the invention) including the physical quantity sensor according to the invention will be described. FIG. 16 is a perspective view showing the example of the altimeter according to the invention.

An altimeter 200 can be worn on the wrist like a wristwatch. The physical quantity sensor 1 (the pressure sensor 100) is mounted in the interior of the altimeter 200, so that the altitude of a current location above sea level, the air pressure of a current location, and the like can be displayed on a display portion 201.

On the display portion 201, various information such as a current time, a user's heart rate, and weather can be displayed.

### 4. Electronic Apparatus

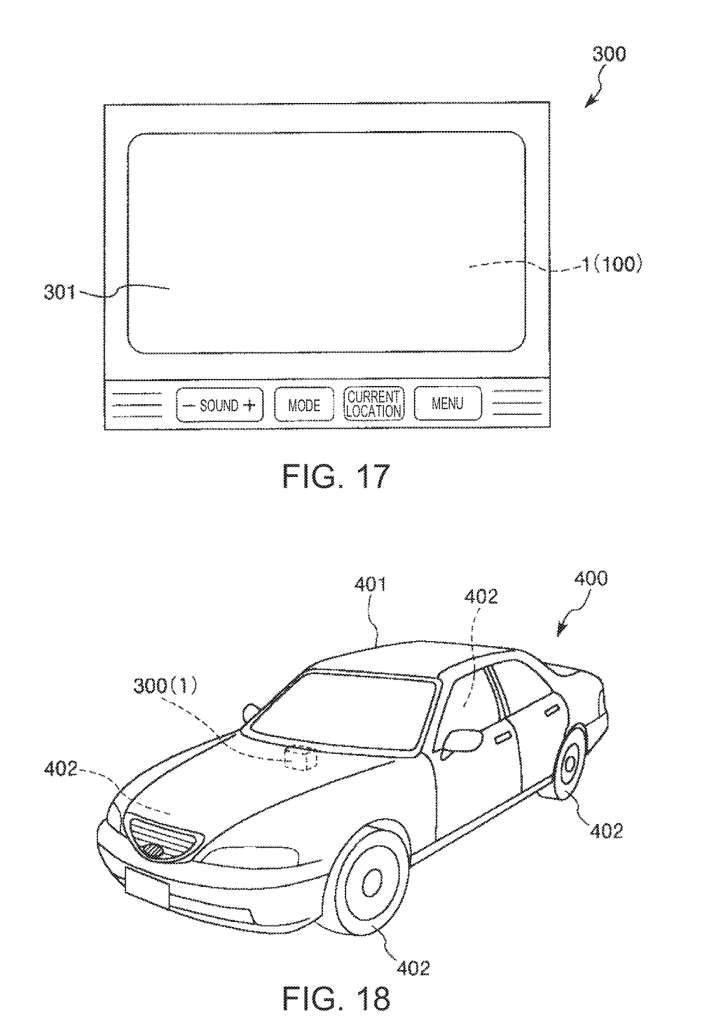

Next, a navigation system to which an electronic apparatus including the physical quantity sensor according to the invention is applied will be described. FIG. 17 is an elevation view showing an example of the electronic apparatus according to the invention.

A navigation system 300 includes map information (not shown), a position information acquiring unit that acquires position information from a global positioning system (GPS), a self-contained navigation unit using a gyro sensor, an acceleration sensor, and vehicle speed data, the physical quantity sensor 1, and a display portion 301 that displays predetermined position information or route information.

According to the navigation system, altitude information can be acquired in addition to acquired position information. For example, when a car runs on an elevated road indicated on the position information at substantially the same position as an open road, the navigation system cannot determine, in the absence of altitude information, whether the car runs on the open road or the elevated road, and therefore, the navigation system provides the user with information on the open road as preferential information. In the navigation system 300 according to the embodiment, altitude information can be acquired by the physical quantity sensor 1, a change in altitude due to the car entering the elevated road from the open road is detected, and thus it is possible to provide the user with navigation information in a running state on the elevated road.

The display portion 301 is composed of, for example, a liquid crystal panel display or an organic electro-luminescence (EL) display, so that reductions in size and thickness are possible.

The electronic apparatus including the physical quantity sensor according to the invention is not limited to that described above, and can be applied to, for example, a personal computer, a mobile phone, a medical apparatus (e.g., an electronic thermometer, a sphygmomanometer, a blood glucose meter, an electrocardiogram measuring system, an ultrasonic diagnosis apparatus, and an electronic endoscope), various kinds of measuring instrument, an indicator (e.g., indicators used in a vehicle, aircraft, and a ship), and a flight simulator.

### 5. Moving Object

Next, a moving object (moving object according to the invention) to which the physical quantity sensor according to the invention is applied will be described. FIG. 18 is a perspective view showing an example of the moving object according to the invention.

As shown in FIG. 18, a moving object 400 includes a car body 401 and four wheels 402, and is configured to rotate the wheels 402 with a source of power (engine) (not shown) provided in the car body 401. Into the moving object 400, the navigation system 300 (the physical quantity sensor 1) is built.

The electronic device, the physical quantity sensor, the pressure sensor, the altimeter, the electronic apparatus, and the moving object according to the invention have been described above based on the embodiments shown in the drawings, but the invention is not limited to the embodiments. The configuration of each part can be replaced with any configuration having a similar function. Moreover, any other components may be added.

Although an example in which the number of piezoresistive elements (functional elements) provided in one diaphragm portion is four has been described in the embodiments, the invention is not limited to the example. The number of piezoresistive elements may be from one to three, or five or more. Moreover, the arrangement, shape, or the like of the piezoresistive elements is not limited to the embodiments described above, and, for example, the piezoresistive element may be disposed at the central portion of the diaphragm portion in the embodiments described above.

Moreover, although an example in which the piezoresistive element is used as a sensor element that detects the deflection of the diaphragm portion has been described in the embodiments described above, the sensor element is not limited to the piezoresistive element and may be, for example, a resonator.

Moreover, although an example in which the electronic device according to the invention is applied to the physical quantity sensor has been described in the embodiments described above, the invention is not limited to the example. The invention can be applied to various types of electronic devices in which a wall portion and a ceiling portion are formed on a substrate using the semiconductor manufacturing process as described above and an interior space is formed by the substrate, the wall portion, and the ceiling portion. In that case, the diaphragm portion can be omitted.

Moreover, although an example in which the plan-view shape of the ceiling portion is rectangular, that is, the ceiling portion includes four right-angled corner portions in the plan view has been described in the embodiments described above, the “corner portion” of the ceiling portion may have a rounded shape, a chamfered shape, or the like in the invention. Moreover, the “two adjacent sides” of the “corner portion configured to include the two sides adjacent to each other in the plan view” include two sides that interpose a rounded portion, a chamfered portion, or the like therebetween.

What is claimed is:

1. An electronic device comprising:
a substrate;
a functional element disposed on one surface side of the substrate;
a wall portion disposed to surround the functional element, in a plan view of the substrate, on the one surface side of the substrate; and
a ceiling portion disposed on the side opposite to the substrate with respect to the wall portion and constituting an interior space together with the wall portion, wherein
the ceiling portion includes
a corner portion configured to include two sides adjacent to each other in the plan view, and
a coupling portion disposed to couple the two sides.

2. The electronic device according to claim 1, wherein
the coupling portion is located on the interior space side of the ceiling portion.

3. The electronic device according to claim 2, wherein
the coupling portion located on the interior space side contains titanium nitride.

4. The electronic device according to claim 1, wherein
the coupling portion is located on the side of the ceiling portion opposite to the interior space.

5. The electronic device according to claim 4, wherein
the coupling portion located on the side opposite to the interior space includes
a first layer configured to contain silicon oxide, and
a second layer disposed on the side opposite to the interior space with respect to the first layer and configured to contain silicon nitride.

6. The electronic device according to claim 1, wherein
the coupling portion includes
a first coupling portion, and
a second coupling portion disposed on the side opposite to the interior space with respect to the first coupling portion, and
at least a portion of the ceiling portion is disposed between the first coupling portion and the second coupling portion.

7. The electronic device according to claim 1, wherein
the coupling portion contains a material with a lower thermal expansion rate than that of the ceiling portion.

8. The electronic device according to claim 1, wherein
the coupling portion includes a portion having a shape extending in a direction inclined to the two sides.

9. The electronic device according to claim 1, wherein
the substrate is provided at a position overlapping the ceiling portion in the plan view, and includes a diaphragm portion that is deflected and deformed under pressure.

10. The electronic device according to claim 9, wherein
the functional element is a sensor element that outputs an electric signal due to strain.

11. A physical quantity sensor comprising the electronic device according to claim 1, wherein
the substrate includes a diaphragm portion that is deflected and deformed under pressure, and
the functional element is a sensor element.

12. A physical quantity sensor comprising the electronic device according to claim 2, wherein
the substrate includes a diaphragm portion that is deflected and deformed under pressure, and
the functional element is a sensor element.

13. A pressure sensor comprising the electronic device according to claim 1.

14. A pressure sensor comprising the electronic device according to claim 2.

15. An altimeter comprising the electronic device according to claim 1.

16. An altimeter comprising the electronic device according to claim 2.

17. An electronic apparatus comprising the electronic device according to claim 1.

18. An electronic apparatus comprising the electronic device according to claim 2.

19. A moving object comprising the electronic device according to claim 1.

20. A moving object comprising the electronic device according to claim 2.
